(19) United States
(12) Patent Application Publication
(10) Pub. No.: US 2007/0232388 A1
(43) Pub. Date: Oct. 4, 2007

(54) GAMING MACHINE

(75) Inventor: Kazunobu SATO, Tokyo (JP)

Correspondence Address: BANNER & WITCOFF, LTD., 1100 13th STREET, N.W., SUITE 1200, WASHINGTON, DC, 20005-4051, US

(73) Assignee: ARUZE CORP., Tokyo (JP)

(21) Appl. No.: 11/695,907

(22) Filed: Apr. 3, 2007

(30) Foreign Application Priority Data
Apr. 3, 2006 (JP) 2006-102369

(51) Int. Cl. A63F 13/00

(52) U.S. Cl. 463/25

(57) ABSTRACT

In the slot machine, if an image acquisition lottery process is won and a selection operating portion is operated, a image information displayed on a display is stored in an image data storage area. If a predetermined amount of the image information is stored in the image data storage area, five card images corresponding to the image information are displayed on the display in a selection bonus game process. If the player selects the card image via a touch panel, a special award corresponding to the selected card image is provided.

### CROSS-REFERENCE TO RELATED APPLICATIONS

This application is based upon and claims a priority from the prior Japanese Patent Application No. 2006-102369 filed on Apr. 3, 2006, the entire contents of which are incorporated herein by reference.

### BACKGROUND

1. Technical Field

Aspects of the present invention relate to a gaming machine which displays symbols on a display device and provides a payout based on a combination of the symbols.

2. Description of Related Art

Conventionally, slot machines and poker games are known as gaming machines which execute a game awarding a payout based on a combination of symbols displayed on a display device. In one example, various symbols are variably stopped and displayed, and if the symbols stopped and displayed match a predetermined combination, a payout or a bonus game corresponding thereto will be awarded.

In a conventional example, a slot machine is constructed to provide an award including a credit or special game corresponding to the combination pattern of five symbols stopped and displayed on one pay line on a monitor. Here, in the slot machine, the symbols are variably stopped and displayed in the five reel portions and the award is provided based on the combination of the symbols in the reel portions in the special game (including spin game, free game) in addition to the base game. That is, in the present example, the symbols are repeatedly variably stopped and displayed in the reel portions during the game, so it may cause the player to feel that the video slot machine is monotonous.

In another example, in recent years, in a personal computer and in a video game, display patterns displayed on a display device are stored as screenshots. And, the image on the network game is stored and can be published on a network (e.g. Internet).

The image saved is mainly used when the result of the game is to be shown to someone or to represent user progress (such as level) within a game. However, the saved image is used mainly as a communication tool and does not improve the interest in the game.

### SUMMARY

In view of the foregoing, one or more aspects of the present invention relate to gaming machine, method of operating a game, computer readable medium having computer-executable instructions or the like that provides an award in accordance with a combination of a symbols. Also, in one or more aspects, image information displayed on a display is stored in a memory. Further, in one or more aspects, the user interface elements are configured to be selectable where the user interface elements are associated with corresponding stored image information, and award is provided based on the image information corresponding to the selected user interface element. One or more of the above aspects of the invention will be more fully described in the following detailed description when read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a perspective view showing a slot machine in a first illustrative embodiment in accordance with one or more aspects of the present invention.

FIG. 2 is an explanatory view showing nine variable display portions of the slot machine in the first illustrative embodiment in accordance with one or more aspects of the present invention.

FIG. 3 is an explanatory view showing eight pay lines of the slot machine in the first illustrative embodiment in accordance with one or more aspects of the present invention.

FIG. 4 is a block diagram showing a control system of the slot machine in the first illustrative embodiment in accordance with one or more aspects of the present invention.

FIG. 5 is an explanatory view showing a RAM in the slot machine in the first illustrative embodiment in accordance with one or more aspects of the present invention.

FIG. 6 is a block diagram showing a display drive circuit of the slot machine in the first illustrative embodiment in accordance with one or more aspects of the present invention.

FIG. 7 is a view showing a video reel variably displayed in the first illustrative embodiment in accordance with one or more aspects of the present invention.

FIG. 8 is an explanatory view showing a lottery table to determine the stopped symbols in nine variable display portions in accordance with one or more aspects of the present invention.

FIG. 9 is an explanatory view showing a payout table to indicate line odds winning combinations and payouts corresponding thereto in one or more embodiments in accordance with one or more aspects of the present invention.

FIG. 10 is an explanatory view showing a payout table to indicate any odds winning combinations and payouts corresponding thereto in one or more embodiments in accordance with one or more aspects of the present invention.

FIG. 11 is a flowchart showing a main process program in first illustrative embodiment in accordance with one or more aspects of the present invention.

FIG. 12 is an explanatory view showing an image acquisition table in accordance with one or more aspects of the present invention.

FIG. 13 is an explanatory view showing one display pattern on the lower display when the free game is won in accordance with one or more aspects of the invention.

FIG. 14 is a flowchart showing a game process program in first illustrative embodiment in accordance with one or more aspects of the present invention.

FIG. 15 is a flowchart showing an image acquisition process program in first illustrative embodiment in accordance with one or more aspects of the present invention.

FIG. 16 is an explanatory view showing one display pattern on the lower display when the image acquisition process is executed in accordance with one or more aspects of the invention.

FIG. 17 is a flowchart showing a selection bonus game process program in first illustrative embodiment in accordance with one or more aspects of the present invention.

FIG. 18 is an explanatory view showing one display pattern on the lower display when the selection bonus game is executed in accordance with one or more aspects of the invention.

FIG. 19 is an explanatory view showing a relation between the card images and the selection contents data.

FIG. 20 is an explanatory view showing an arrangement pattern lottery table in accordance with one or more aspects of the present invention.

FIG. 21 is an explanatory view showing one display pattern on the lower display after the card image is selected in accordance with one or more aspects of the invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine according to the invention will be described in detail with reference to the drawings based on an embodiment embodying one or more aspects of the invention as a slot machine. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application that runs in a processor or processors. Further, the terms “CPU” and “processor” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that the invention may be implemented as computer executable instructions on a computer readable medium such as a non-volatile memory, a magnetic or optical disc or an audio-frequency, radio-frequency or optical carrier wave.

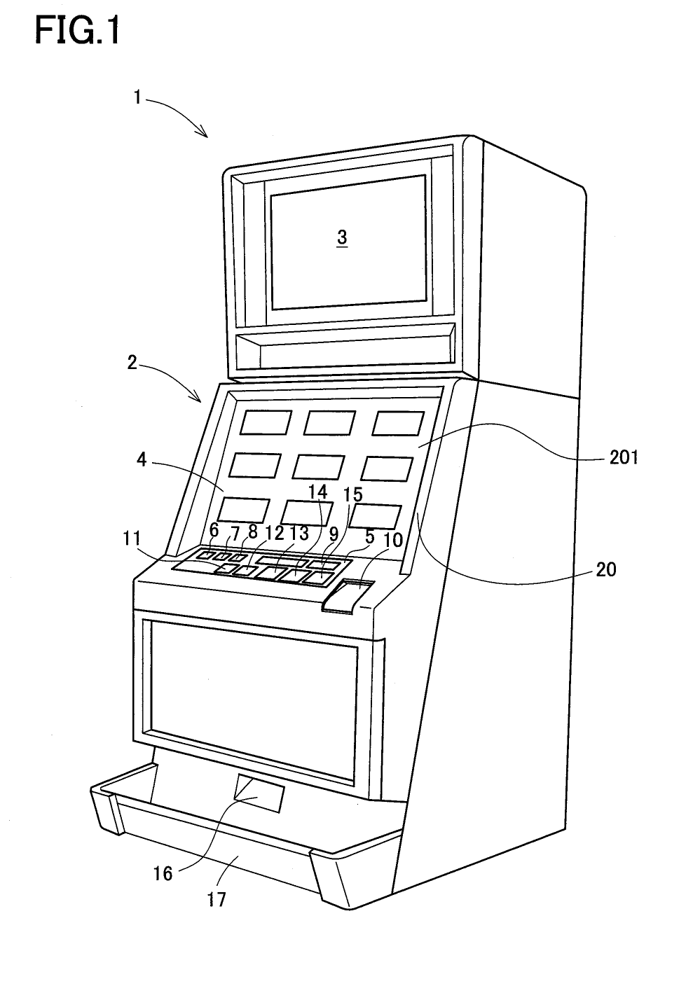

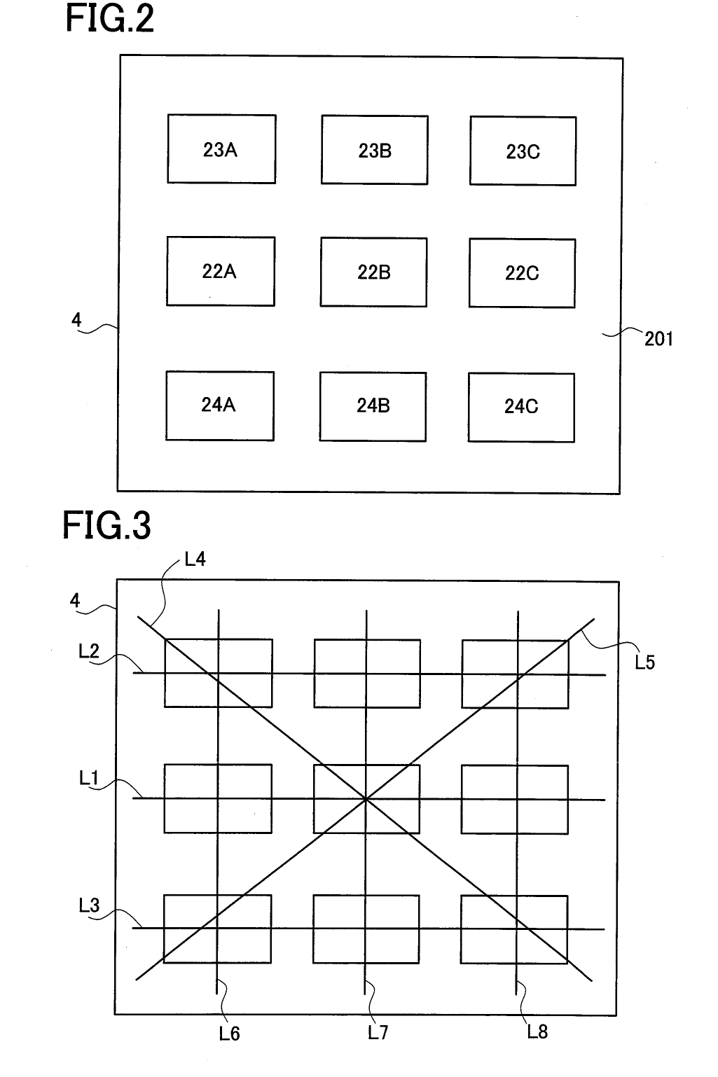

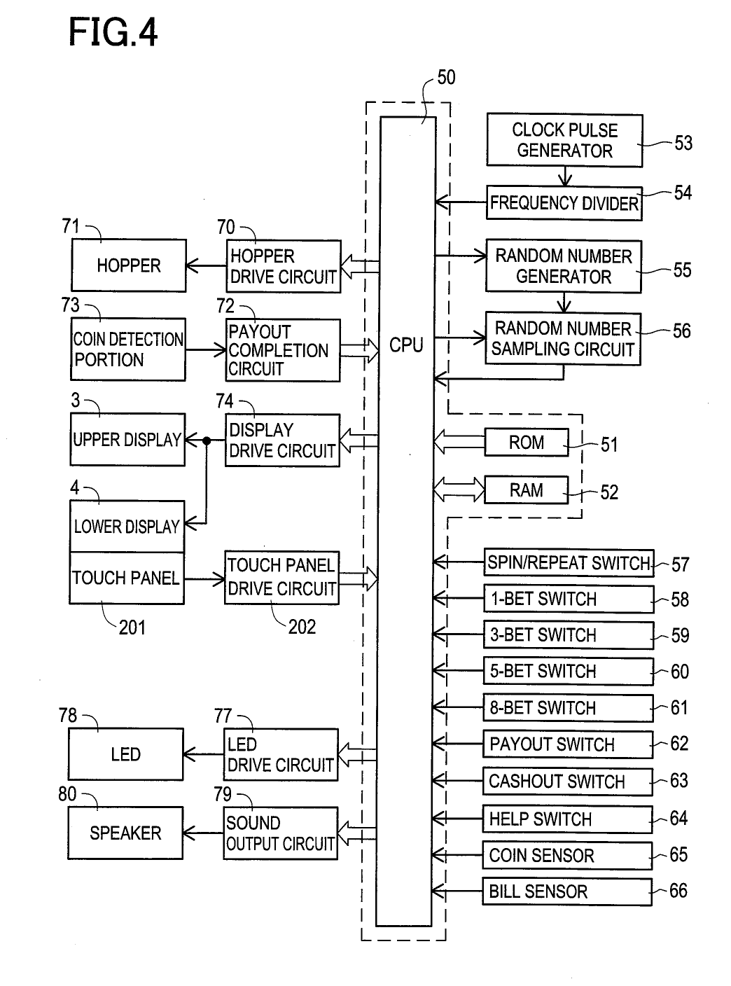

At first, a construction of a slot machine according to one or more embodiments will be described with reference to FIGS. 1 to 4. FIG. 1 is a perspective view showing a slot machine. FIG. 2 is a perspective view showing nine variable display portions. It is appreciated that the number of variable display portions may be other values as well (including but not limited from two to twenty five, for instance). FIG. 3 is a perspective view showing eight pay lines. Here again, the number of pay lines is variable. FIG. 4 is a block diagram showing an example of a control system of the slot machine.

As shown in FIG. 1, a slot machine 1 has a cabinet 2. An upper display 3 is positioned in the upper front part of the cabinet 2, and a lower display 4 is positioned on a device front panel 20 positioned in the front center part of the cabinet 2. Displays 3 and 4 may be CRTs, liquid crystal displays, plasma displays, LED displays, OLED displays, and other known display technologies. For instance, one or both the upper display 3 and the lower display 4 may be a liquid crystal display. A transparent touch panel 201 is positioned on the front surface of the lower display 4. Transparent touch panel 201 may form part or all of a selection device. It is appreciated that other structures may be used in place of touch panel 201 including buttons and the like. The term “selection device” encompasses various structures that permit a user to select an item. It is appreciated that CRTs and other display technologies may be used in place of or in conjunction with the displays 3 and 4. Further, in some aspects, the upper display 3 and the lower display 4 may be combined into a single display or further separated into three or more displays.

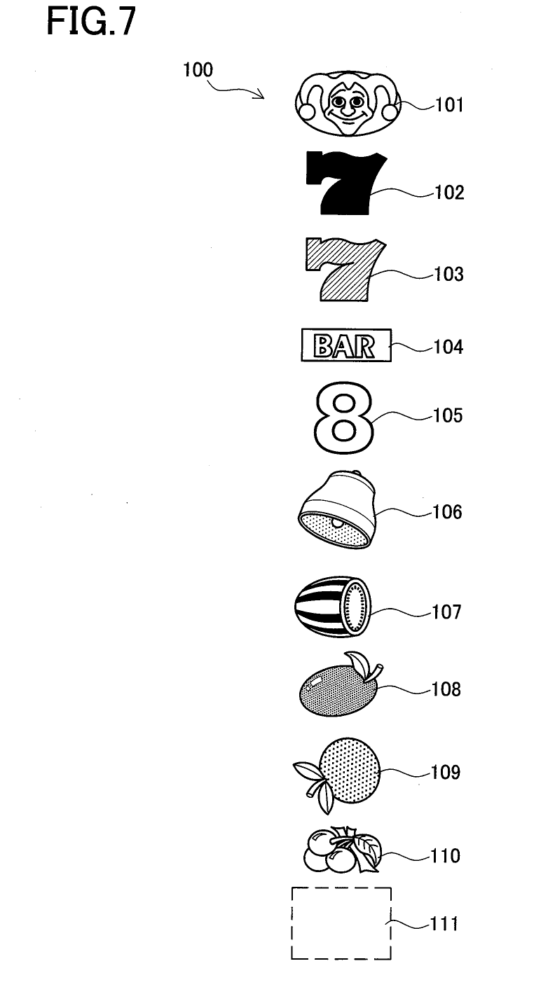

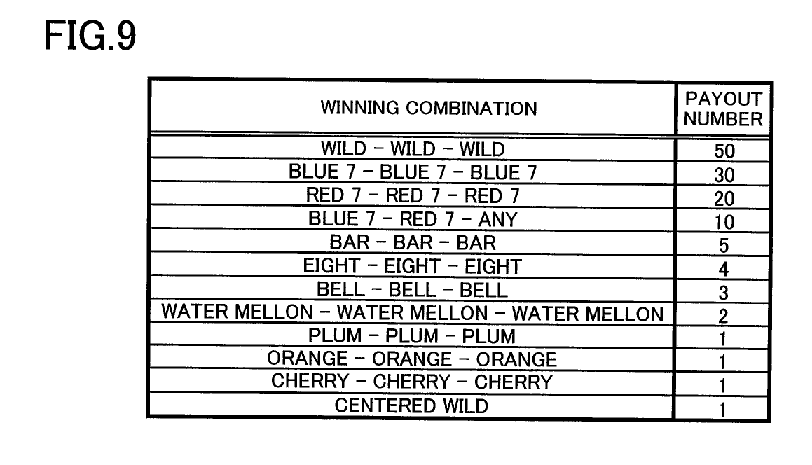

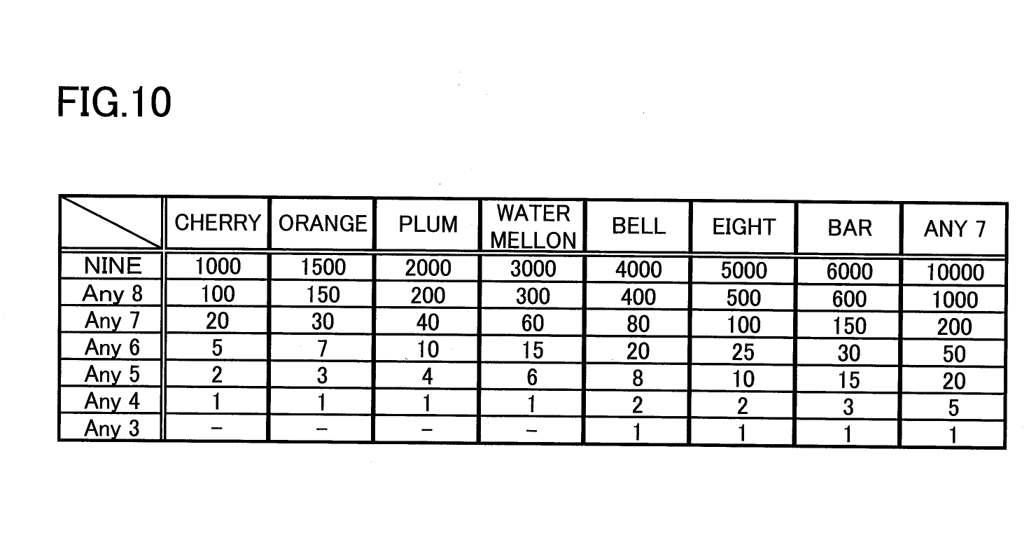

The upper display 3 displays information on a game such as a game method, a payout table indicating kinds of winning combinations and payouts corresponding thereto (see FIGS. 9 and 10), and various effects on the game. On the other hand, the lower display 4 displays a number of variable display portions (for example, nine variable display portions) 22A to 22C, 23A to 23C, and 24A to 24C shown in FIG. 2. The lower display 4 displays a number of pay lines “L1” to “L8” (for example, eight pay lines) as shown in FIG. 3. Here, in each of the display portions 22A to 22C, 23A to 23C, and 24A to 24C, variable displays may be displayed as part or all of a video reel 100. That is, various kinds of symbols to form the video reel 100 (see FIG. 7) are displayed while being scrolled from the right to the left (or scrolling in other directions) in each of the display portions 22A to 22C, 23A to 23C, and 24A to 24C. Other types of displays may be used to display the display portions 22A to 22C, 23A to 23C, and 24A to 24C including but not limited to flashing, fading, wiping, and other transition techniques.

An operation table 5 formed by projecting to proximal side is provided at the bottom of the lower display 4. A CHANGE button 6, a CASHOUT button 7, and a HELP button 8 are arranged on the operation table 5 (for instance, arranged on the left side). A coin insertion slot 9 and a bill insertion portion 10 may be located to the right of the HELP button 8. A 1-BET button 11, a SPIN/REPEAT BET button 12, a 3-BET button 13, a 5-BET button 14, and an 8-BET button 15 may be arranged on the forward part of the operation table 5.

The CHANGE button 6 is a button to be pressed when the bill inserted in the bill insertion portion 10 is to be returned to a player in the form of one or more coins. Changed coins dispensed on the basis of a press operation of the CHANGE button 6 are paid out through a coin payout opening 16 to a coin tray 17, which may be formed at the lower part of the cabinet 2. A CHANGE switch 62, which will be described later, may be attached to the CHANGE button 6.

After a game has ended, the CASHOUT button 7 is pressed to retrieve the player's remaining coins. When the CASHOUT button 7 is pressed, coins won in games are paid out through the coin payout opening 16 to the coin tray 16. A CASHOUT switch 63, which will be described later, is attached to the CASHOUT button 7.

The HELP button 8 is a button to be pressed when a player cannot understand game operation method. When the HELP button 8 is pressed, various help information is displayed on the upper display 3. A HELP switch 64, which will be described later, is attached to the HELP button 8.

A coin sensor 65, which will be described later, is arranged in relation to the coin insertion slot 9. When the coin (s) is inserted in the coin insertion slot 9, the coin sensor 65 detects coin (s) inserted and a coin detection signal, which is generated from the coin sensor 65, may be output to the CPU 50 (see FIG. 4). A bill sensor 66, which will be described later, is arranged in relation to the bill insertion portion 10. When the bill is inserted in the bill insertion portion 10, a bill detection signal, which is generated from the bill sensor 66, may be output to the CPU 50 (see FIG. 4).

The 1-BET button 11 is a button to bet one bet every press of the 1-BET button 11. A 1-BET switch 58 is attached to the 1-BET button 11. In the slot machine 1 of one or more embodiments, all pay lines “L1” to “L8” are activated on the basis of one bet.

A SPIN/REPEAT BET button 12 is a button to start the game with the present bet number or the previous bet number on the basis of a press of the button 12. If the SPIN/REPEAT BET button 12 is pressed, variably display of the symbols in each of the variable display portions 22A to 22C, 23A to 23C, and 24A to 24C will start. A spin switch 57, which will be described later, is attached to the SPIN/REPEAT BET button 12. Here, in one or more embodiments, the bet number, which can be betted by pressing of the SPIN/REPEAT BET button 12 can be any value including but not limited to one, two, three, five, or eight.

The 3-BET button 13, the 5-BET button 14, and the 8-BET button 15 are buttons to bet three, five, and eight bets on the basis of a press operation thereof. A 3-BET switch 59, a 5-BET switch 60, and an 8-BET switch 61 are attached to the 3-BET button 13, the 5-BET button 14, and the 8-BET button 15, respectively.

The coin payout opening 16 and the coin tray 17 may be formed at a lower position of the cabinet 2. The coin payout opening 16 is the portion in which coin (s) is paid on the basis of press operation of the CHANGE button 6 or the CASHOUT button 7. The coin tray 17 is the portion for receiving coins paid out from the coin payout opening 16. The coin detection portion 73, which is constructed from the sensor etc., is arranged inside the coin payout opening 16. The coin detection portion 73 detects the number of coins paid out from the coin payout opening 16 (see FIG. 4).

Next, the construction of the control system in the slot machine 1 will be described with reference to FIG. 4. FIG. 4 is a block diagram schematically showing the control system in the slot machine 1. As shown in FIG. 4, the control system in the slot machine 1 may be constructed from a CPU 50 as a core. A ROM 51 and a RAM 52 are connected to the CPU 50. In the ROM 51, various programs for controlling the slot machine 1 and data tables are stored. For example, various control programs including a main process program, which will be described later and various data tables (including a lottery table associating a value of a random number and a symbol to be displayed) may be stored in the ROM 51.

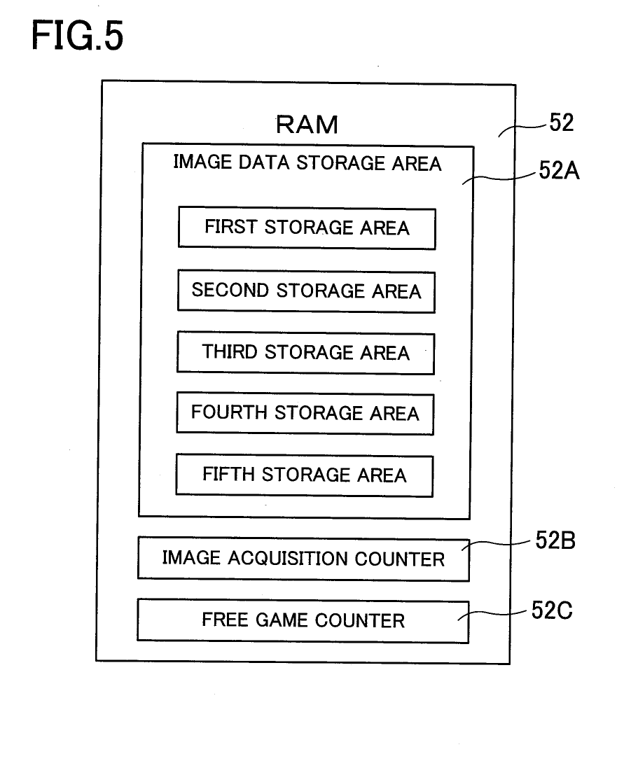

The RAM 52 is a temporary memory for storing various data processed by the CPU 50. Here, in the RAM 52 of the slot machine 1 of one or more embodiments, as shown in FIG. 5, an image data storage area 52A, an image acquisition counter 52B, and a free game counter 52C are formed. The image data storage area 52A is the storage area in which the image data acquired in the image acquisition process (S6) which will be described later is stored. The first storage area to the fifth storage area are formed in the image data storage area 52A, and in each of the storage area, one image data acquired in the image acquisition process (S6) is stored. Here, the number of storage areas is variable. Hereinafter, the image data stored in the first storage area may be called “the first image data”. In a similar way, the image data stored in the second storage area to the fifth storage area is called “the second image data” to “the fifth image data”, respectively. The image stored in the image data storage area 52A is used when a special award contents image 251 indicating a special award corresponding to a card image 250 selected by the player is displayed in the selection bonus game process (S10) which will be described later. Here, the image corresponding to the special award is variable. It is appreciated that the image corresponding to the special award may be other display object as well (including but not limited circle, for instance). The card image may form part or all of a user interface element. It is appreciated that other structures may be used in place of user inter face including buttons and the like. The term “user interface element” encompasses various structures that permit a user to select an item. And, the special award contents image is variable. In addition to the data indicating the image corresponding to the image data, the award data indicating the award contents (for example, the payout) provided based on the combination of the symbols corresponding to the image data is stored in the storage area.

The image acquisition counter 52B is the storage to count the number of the times in which the image data is stored in the image data storage area 52A in the image acquisition process (S6). That is, the value of the image acquisition counter 52B is added to “1” every time the image data is stored in the image data storage area 52A in the image acquisition process (S6). At a result, the number of the image data stored in the image data storage area 52A can be counted by referring to the value of the image acquisition counter 52B. In one or more embodiments, if the image data is stored in the first storage area to the fifth storage area respectively, it will be determined that the selection bonus game (S10) can be executed. If the selection bonus game is executed, the value of the image acquisition counter 52B will be set to “0”.

The free game counter 52C is the storage to count the number of the times of the game in the free game process (S8). In the slot machine 1 in one or more embodiments, in the free game process (S8), the free game, which symbols are variably stopped and displayed in the variable display portions with the previous bet number without the consumption of credit, is executed five times. That is, in the slot machine 1 in one or more embodiments, in the free game process (S8), the value of the free game counter 52C is added to “1” every time the variably stop and display is conducted in the variable display portions. If the value reaches the predetermined number (namely, “5” for instance), the free game process (S8) will be finished. Here, in the free game (S8) in one or more embodiments, while “WILD” 101 is fix-displayed in the variable display portion 22B, the variably stops and displays are performed in other variable display portions.

A clock pulse generator 53 for generating standard clock pulses and a frequency divider 54 are connected to the CPU 50. Further, a random number sampling circuit 56 for generation random numbers are connected to the CPU 50. Here, the random numbers sampled by the random number sampling circuit 56 is used in various lotteries including the winning combinations. Further, switches attached every button on the operation table 5 are attached, respectively. That is, a SPIN/REPEAT switch 57, a 1-BET switch 58, a 3-BET switch 59, a 5-BET switch 60, an 8-BET switch 61, a CHANGE switch 62, a CASHOUT switch 63, and a HELP switch 64 are connected to the CPU 50, respectively. If the CPU 50 receives the switch signal output from each switch on the basis of press operation thereof, the CPU 50 will control various operations corresponding to the button in which the switch signal from thereof received.

Further, a coin sensor 65 and a bill sensor 66 are connected to the CPU 50, respectively. The coin sensor 65 detects coins inserted from the coin insertion slot 9. Herewith, the CPU 50 can calculate the number of inserted coins based on the coin detection signal output from the coin sensor 65. The bill sensor 66 detects the kind and sum of the bill inserted from bill insertion portion. The CPU 50 calculates the number of coins equal to the sum of bill based on that bill detection signal.

A hopper 71 is connected through a hopper drive circuit 7 to the CPU 50. If a drive signal, which is generated from the CPU 50, is output to the hopper drive circuit 70, the hopper 71 will pay out a predetermined number of coins from the coin payout opening 16. A coin detection portion 73 arranged in the coin payout opening 16 is connected to the CPU 50 through the payout completion signal circuit 72. If the coin detection portion 73 detects that a predetermined number of coins are paid out from the coin payout opening 16, a coin payout detection signal will be output to the payout completion signal circuit 72. The payout completion signal circuit 72 outputs a payout completion signal to the CPU 50 based on the coin payout detection signal. Further, the upper display 3 and the lower display 4 are connected through the display drive circuit 74 to the CPU 50. Hence, the display contents of the upper display 3 and the lower display 4 are controlled by the CPU 50, respectively. And, when the procedure is shifted to the image acquisition process (S6) which will be described later, the display drive circuit 74 generates the image data corresponding to the split pattern data which will be described later based on the display pattern displayed on the lower display 4 (the combination of the symbols stopped and displayed in each of the variable display 22A to 22C, 23A to 23C, and 24A to 24C) and outputs to the CPU 50. Here, the image data output is stored in each of the storage area (the first storage area to the third storage area) of the image data storage area 52A.

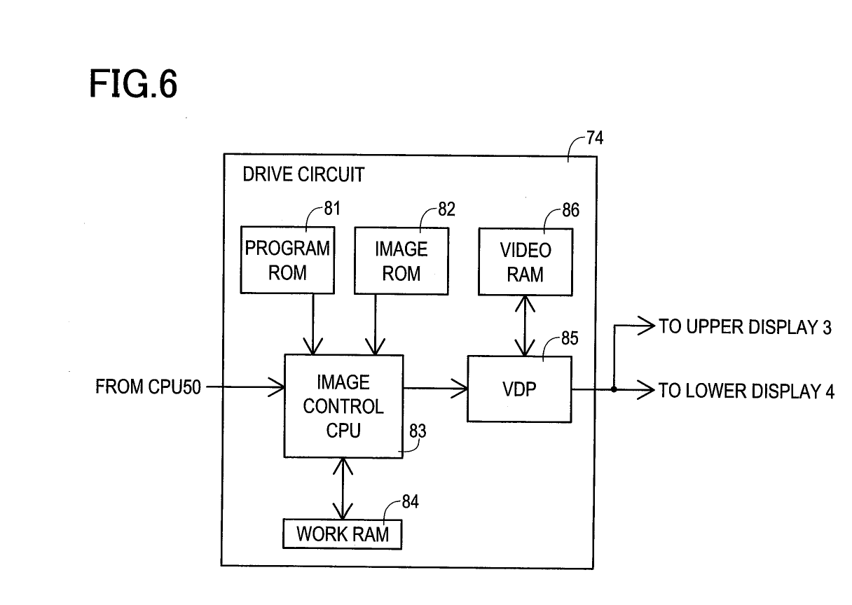

Here, as shown in FIG. 6, the display drive circuit 74 is constructed from a program ROM 81, an image ROM 82, an image control CPU 83, a work RAM 84, a VDP (video display processor) 85, and a video RAM 86. An image control program related to the display on the upper display 3 and the lower display 4, and various selection tables are stored in the program ROM 81. The image data to form images, for example, various images of the demonstration effects conducted on the lower display 3 and upper display 4 and the help information and the payout table displayed on the upper display 3 are stored in the image ROM 82. Here, in the image ROM 82, the image data to form images of the symbols displayed in the variable display portions 22A to 22C, 23A to 23C, and 24A to 24C (see FIG. 2) on the lower display 4 are also stored. The symbols displayed in the variable display portions 22A to 22C, 23A to 23C, and 24A to 24C will be described later. The image control CPU 83 determines the images displayed on the upper display 3 and the lower display 4 among the image data stored beforehand in the image ROM 82 according to the image control program stored beforehand in the program ROM 81 based on parameters set by the CPU 50. The work RAM 84 functions as a temporary memory when the image control program is executed in the image control CPU 83. The VDP 85 forms images corresponding to display contents determined by the image control CPU 83, and the VDP 85 outputs the images formed thereby to the upper display 3 and the lower display 4. Thereby, for example, each of the symbols is variably displayed and stopped in the variable display portions 22A to 22C, 23A to 23C, and 24A to 24C on the lower display 4. The video RAM 86 functions as a temporary memory when the images are formed by the VDP 85.

The touch panel 201 is connected through a touch panel drive circuit 202 to the CPU 50. As mentioned above, the touch panel 201 is arranged on the image screen of the lower display 4. The CPU 50 can recognize the place where the player touches based on the coordinate information of the portion touched by the player based on the touch panel drive circuit 202, namely the CPU 50 can recognize an operation of the touch panel 201. That is, an operation of an image acquisition selection portion 210 in an image acquisition process (S6) and a selection operation of a card image 250 in a selection bonus game process (S10) are conducted on the basis of the touch panel 201 operation by the player.

LEDs 78 are connected through a LED drive circuit 77 to the CPU 50. Many LEDs 78 are arranged on the front face of the slot machine 1, and are controlled by the LED drive circuit 77. LEDs 78 are controlled based on the drive signal from the CPU 50 when various effects are produced. A sound output circuit 79 and a speaker 80 are connected to the CPU 50. The speaker 80 reproduces various effect sounds when various effects are produced based on the output signal from the sound output circuit 79.

Next, the symbols used in the game of the slot machine 1 will be described. FIG. 7 is a view showing a symbol row (video reel), which is variably displayed while being scrolled in each of the variable display portions 22A to 22C, 23A to 23C, and 24A to 24C. Here, the video reel 100 is constructed from the symbol row constructed from various symbols. For the purposes of explanation, the various symbols may include “WILD” 101, “BLU7” 102, “RED7” 103, “BAR” 104, “EIGHT” 105, “BELL” 106, “WATER MELLON” 107, “PLUM” 108, “ORANGE” 109, “CHERRY” 110, and “BLANK” 111. Here, kinds of symbols are variable. And, the number of symbols is variable.

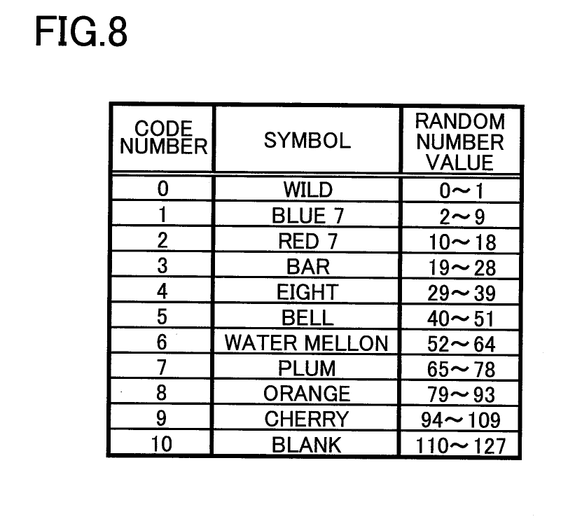

As mentioned above, in the slot machine 1, in the variable display portions 22A to 22C, 23A to 23C, and 24A to 24C (for instance, nine), the symbols are variably displayed by the video reel 100, and one symbol is stopped and displayed in each of the variable display when the predetermined time elapses. Here, the lottery table, which is used when the symbols stopped and displayed in each of the variable display portions 22A to 22C, 23A to 23C, and 24A to 24C are determined, will be described with reference to FIG. 8 FIG. 8 is an explanatory view showing the lottery table of the stopped and displayed symbols used when the game is performed by using variable display portions. Here, the lottery table shown in FIG. 7 is stored in the ROM 51.

Stopped and displayed symbols in each of the variable display portions 22A to 22C, 23A to 23C, and 24A to 24C are determined every each variable display portion 22A to 22C, 23A to 23C, and 24A to 24C. Therefore, a code number, which lies in a range of “0” to “10” for instance, is allotted to each of the symbols (“WILD” 101, “BLU7” 102, “RED7” 103, “BAR” 104, “EIGHT” 105, “BELL” 106, “WATER MELLON” 107, “PLUM” 108, “ORANGE” 109, “CHERRY” 110, and “BLANK” 111, for instance) to form the video reel 100 (see FIG. 7). The lottery table (see FIG. 8) in which each of the code numbers is set for the range of the random number value is stored in the ROM 51. Further, nine random number values are sampled by the random number sampling circuit 56 so as to correspond to each of the variable display portions 22A to 22C, 23A to 23C, and 24A to 24C. At a result, the symbols which are stopped and displayed in each of the variable display portions 22A to 22C, 23A to 23C, and 24A to 24C are determined based on the code numbers.

It will be specifically described in this point. For example, in a case where the random number is sampled for each of the symbols to form the video reel 100 in the variable display portion 23A through the random number sampling circuit 56, if the random number value lies in a range of 0 to 1, the code number of the variable display portion 23A will be “0” based on the lottery table (see FIG. 8). Thereby, the symbol stopped and displayed in the variable display portion 23A is the symbol “WILD” 101 corresponding to the code No. 0. Thereby, when scrolled display executed in a predetermined time is finished, the symbol “WILD” symbol 101 is stopped and displayed in the variable display portion 23A. Below, each of the code numbers “1” to “9” is processed in the same way based on the symbol lottery table (see FIG. 8). Here, the stopped and displayed symbol will be determined as well as each other symbol to form the video reel 100 in the variable display portion 22A.

Next, the winning combinations and the payouts thereof in the slot machine 1 will be described with reference to FIGS. 9 and 10. FIG. 9 is an explanatory view showing the payout table indicating the line odds winning combinations and the payouts thereof. As shown in FIG. 9, the line odds payout table holds a payout number in which the symbols stopped and displayed in three display portions (see FIG. 2) on some activated pay line among each of the activated pay lines (see FIG. 3) on the lower display 4 are predetermined combination. For example, concerning the variable display portions 22A to 22C, 23A to 23C, and 24A to 24C, if all code numbers for the variable display portions (for example, variable display portion 22A to 22C) on some pay line (for example, pay line L1) among pay lines are any of “2” to “19”, “BLUE7-BLUE7-BLUE7” is won (see FIG. 9) for this pay line. In this case, all code numbers of variable display portion on that pay lines are “2”, and the symbol “BLUE7” 102 is stopped and displayed in that variable portions (see FIG. 8). The payout number “30” will be acquired to the player. Here, the payout number is variable. In a case where there exists plural pay lines for each of which “BLUE7-BLUE7-BLUE7” is won, the payout number calculated by multiplying the number of pay lines by “30” will be obtained. Similarly to this, each payout number of line odds will be determined based on the payout table of the line odds as shown in FIG. 9.

Here, essentially, if all symbols stopped and displayed in three variable display portions on some activated pay line are same, the line odds winning combination is won, and in one or more embodiments, even though all symbols stopped and displayed in three variable display portions are not same, the line odds winning combination may be won. For example, in the winning combination “BLUE7-RED7-ANY” as shown in FIG. 9, if the symbols stopped and displayed in two variable display portions among three variable display portions on some activated pay line are “BLUE7” 102 and “RED7” 103, above winning combination will be won even though the symbol stopped and displayed in the rest of the variable display portion is any of symbols (“WILD” 101 to “BLANK” 111). In this case, the payout number “10” will be acquired based on the winning combination “BLUE7-BLUE7-BLUE7” (see FIG. 9). And, if the symbol stopped and displayed in the variable display portion 22B is “WILD” 101, the outcome “CENTERD WILD” will be won and the payout number “1” will be acquired (for example, see FIG. 15). Here, in this case, the award in which the bonus game process (S11) can be executed, which will be described later, will be also acquired. In the bonus game process (S11) shifted at this time, the free game in which the game conducted predetermined times (five times) without consumption of credit. In above free game, while “WILD” 101 is stopped and displayed in the variable display portion 22B, the game, which the variably and stopped displays are performed in other eight variable display portions, is conducted. The bonus game process (S11) will be described in detail later.

And, “WILD” 101 is the wild card which can be regarded other any symbol (for example, “BLUE7” 102 to “CHERRY” 110). Thereby, if “WILD” 101 is displayed in any of the variable display portions on some pay line, the combination of other variable display portions fit the combination shown in FIG. 9, the line odds will be won. For example, when “WILD” 101 is stopped and displayed in variable display portion 22C out of variable portions from 22A to 22C, if the symbols stopped and displayed in the variable display portions 22A and 22B are “WATER MELLON” 107, the winning combination “WATER MELLON” will be won.

In addition, in one or more embodiments, the line odds winning combination is set to the condition shown in FIG. 9, however, the winning combination not shown in FIG. 9 can be set as the winning combination. For example, above winning combination “BLUE7-RED7-ANY” can be replaced by winning combination “ANY3 of 7. In this winning combination “ANY3 of 7”, all symbols stopped and displayed in the three variable display portions on some pay line are “BLUE7” 102 or “RED7” 103, above winning combination will be won.

In one or more embodiments, the payout will awarded on the basis of the number of same symbols (including “WILD” 101) stopped and displayed in each of the variable display portions (see FIG. 2) on each of the activated pay lines (see FIG. 3) on the lower display 4. In the any odds payout table as shown in FIG. 10, the payout number acquired in this case is set based on the symbols and the number of the same symbols. For example, if five sampled random values corresponding to five variable display portions among nine variable display portions 22A to 22C, 23A to 23C, and 24A to 24C lie in a range of random value “65” to “78”, “ANY-5 of PLUM” will be won. In this case, five code numbers corresponding to five variable display portions among nine variable display portions 22A to 22C, 23A to 23C, and 24A to 24C are “7” (see FIG. 8) and “PLUM”s 108 are stopped and displayed respectively. And, the payout number “4” corresponding to the winning combination “ANY-5 of PLUM” is acquired for the player based on the random result (see FIG. 10). The payout number corresponding to other winning combination of the any odds are acquired based on the any odds payout table as shown in FIG. 10 in the same way. In addition, in this case, “WILD” 101 also functions as the wild card. That is, in nine variable display portion, if “WILD” 101 and four “PLUM”s 108 are stopped and displayed, as mentioned above, “ANY-5 of PLUM” will be won and the payout number “4” corresponding to the winning combination “ANY-5 of PLUM” is acquired for the player.

Here, in the slot machine 1 in one or more embodiments, all pay lines (for instance, all eight pay line) are activated with one bet, so with respect to the variable display portions 22A to 22C, 23A to 23C, and 24A to 24C, it requires that five variable display portions are the same. However, in one or more embodiments in which activated pay lines are variable based on the bet number, it is determined whether any odds win based on the number of the same symbols in the symbols displayed in the variable display portions corresponding to the activated pay lines.

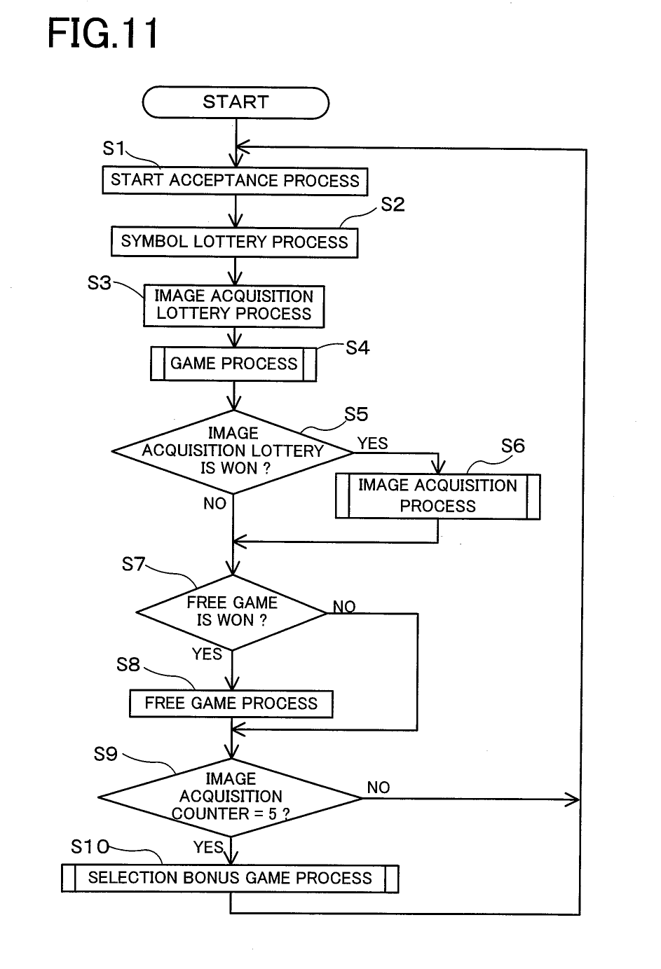

Next, the main process program executed in the slot machine 1 will be described reference to FIG. 11. FIG. 11 is a flowchart of the main process program. As shown FIG. 11, when the main process program is executed, at first, the initial settings such as reset for the storage area of the RAM 52 and the counter value are performed. After that, the CPU 50 executes the start acceptance process (S1). In the start acceptance process (S1), the game, in which the bet value at one game is determined and the game is started, is executed. Concretely, the CPU 50 displays activated pay lines on the lower display 4 based on the switch signal from operated button (namely, the start signal) when the 1-BET button 11, the SPIN/REPEAT BET button 12, the 3-BET button 13, the 5-BET button 14, or the 8-BET button 15 (hereinafter “1-BET button or the like” as a generic term of above buttons) is operated. In this time, the line odds payout table (see FIG. 9) and the any odds payout table (see FIG. 10) are displayed on the upper display 3. The CPU 50 stores the bet number value, which is bet on the basis of a press operation of the 1-BET button of the like, in the RAM 52, and shifts the procedure to the symbol lottery process (S2).

When the procedure is shifted to the symbol lottery process (S2), the CPU 50 determined the symbols to be stopped and displayed in each of the variable display portions 22A to 22C, 23A to 23C, and 24A to 24C, and executes the process, in which the winning combination in the game is determined. Concretely, the CPU 50 determines nine random values in a range of “0” to “127” (for instance) corresponding to each of the variable display portions 22A to 22C, 23A to 23C, and 24A to 24C through the random number sampling circuit 56. The CPU 50 determines the stopped and displayed symbols based on the sampled random number values and the lottery table (see FIG. 8) via the code numbers. In the symbol lottery process (S2), after nine stopped and displayed symbols are determined, the CPU 50 stores the random result in the RAM 52, and the procedure is shifted to the image acquisition lottery process (S3).

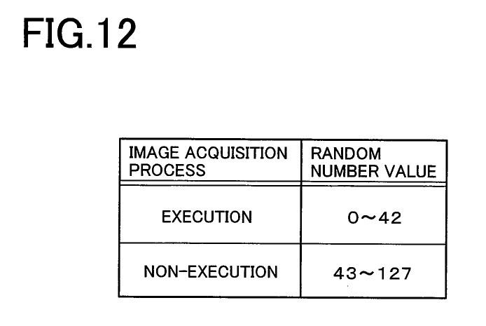

In S3, the CPU 50 executes the image acquisition lottery process. In the image acquisition lottery process (S3), the CPU 50 determines whether the image acquisition process (S6) can be executed randomly. Concretely, the CPU 50 determines one random value in a range of “0” to “127” through the random number sampling circuit 56. And, the CPU 50 determines whether the image acquisition process (S6) can be executed based on the random number value and the image acquisition lottery table (see FIG. 12). For example, the random number value sampled by the random number sampling circuit 56 lies in a range of “0” to “42”, the CPU 50 determines that the image acquisition lottery is won (namely, the execution of the image acquisition process (S6) is allowed). After the random result in the image acquisition lottery process is stored in the RAM 52, the CPU 50 shifts the procedure to the game process (S4).

When the procedure is shifted to S4, the CPU 50 executes the game process. In this game process (S4), the CPU 50 variably stops and displays the video reel 100 in each of the variable display portions 22A to 22C, 23A to 23C, and 24A to 24C, and the combination of the symbols are displayed on the lower display 4 based on the symbol lottery process (S2). And, the award (the payout number or the free game) will be provided to the player based on the combination of the stopped and displayed symbols (the line odds winning combination and the any odds winning combination). After these processes are executed, the CPU shifts the procedure to S5. The game process (S4) will be described reference to the drawing in detail later.

Next, in S5, the CPU 50 determined whether the image acquisition lottery is won by reading the random result of the image acquisition lottery process (S3). If the image acquisition lottery is won (S5: YES), the CPU 50 will shift the procedure to the image acquisition process (S6). On the other hand, the image acquisition lottery is not won (S5: NO), the CPU 50 will shift the procedure to S7 directly.

When the procedure is shifted to the image acquisition process (S6), the CPU 50 displays the image acquisition selection portion 210 on the lower display 4, and stores the display contents displayed on the lower display 4 in the storage areas (the first storage area to the fifth storage area) of the image data storage area 52A, as the image data. After the image data, which indicate the display contents displayed on the lower display 4, stored in the image data storage area 52A, the CPU 50 finishes the image acquisition process (S6) and shifts the procedure to S7. The image acquisition process (S7) will be described in detail with reference to the drawings later.

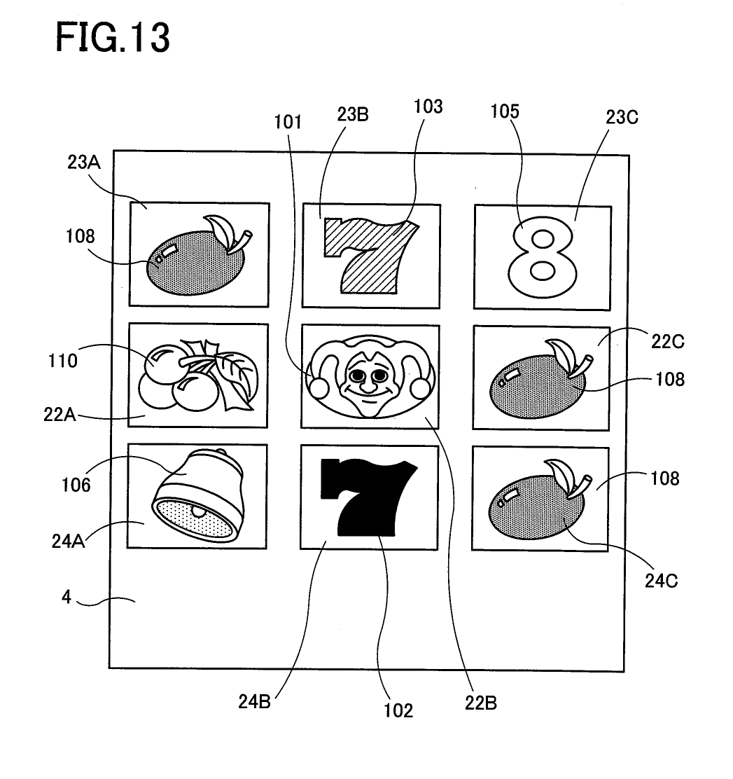

In S7, the CPU 50 determines whether the free game is won in the game executed in S1 to S4. That is, the CPU 50 determines whether the symbol displayed in the variable display portion 22B is “WILD” 101 based on the display contents displayed on the lower display 4 (namely, the random result of the symbol lottery process (S2)). If “WILD” 101 is stopped and displayed (see FIG. 13) and the free game is won (S7: YES), the CPU 50 will shift the procedure to the free game process (S8). On the other hand, if the symbol displayed in the variable display portion 22B is other than “WILD” 101 (for example, “BLUE7” 102 to “BLANK” 111) (S7: NO), the CPU 50 will shift the procedure to S9 directly. Here, if “the free game is won” is provided as the special bonus in the game result of the selection bonus game process (S10) (which will be described), it may be determined that the free game is won (S7: YES) in S7 in which will be executed after the selection bonus game is executed, regardless of the random result in the symbol lottery process (S2) in this game.

When the procedure is shifted to S8, the CPU 50 executes the free game process. In the free game process (S8), the free game is performed five times. In the free game, as mentioned above, while “WILD” 101 is fix-displayed in the variable display portion 22B, the lotteries of eight other variable display portions are conducted, and the symbols are variably stopped and displayed in other eight variable display portions (namely, variable display portions 22A, 22C, 23A to 23C, and 24A to 24C). When the finish of five free games is detected based on the valued of the free game counter 52C (namely, five free games are finished), the payout number acquired in five free games to the player. After that, the CPU 50 finishes the free game process (S8), and shifts the procedure to S9.

In S9, the CPU 50 determines whether the value of the image acquisition counter 52 is “5” by referring to the value of the image acquisition counter 52B. As mentioned above, the image acquisition counter 52B is added to “1” every time the image data is stored in the image data storage area 52A, so it is determined whether the image data is stored in all of the first storage area to the fifth storage area in S9. If the value of the image acquisition counter is “5” (S9: YES), the CPU will shift the procedure to the selection bonus game process (S10). On the other hand, the value of the image acquisition counter 52B is not “5” (S9: NO), the CPU 50 will shift to S1 directly.

In the selection bonus game process (S10) in one or more embodiments, the bonus game, in which five card images (the card images 250A to 250E) are displayed on the lower display 4 and the special award is provided on the basis of that the player selects the card image, is executed. Each of the card images 250 corresponds to the image data stored in the image data storage area 52A, respectively. If any card image 250 is selected among five card images 250, the special award will be provided based on the image data corresponding to above card image 250. After the card image 250 is selected by the player and the special award corresponding to the random result is provided (including that no award is provided), the CPU 50 returns the procedure to the start acceptance process (S1).

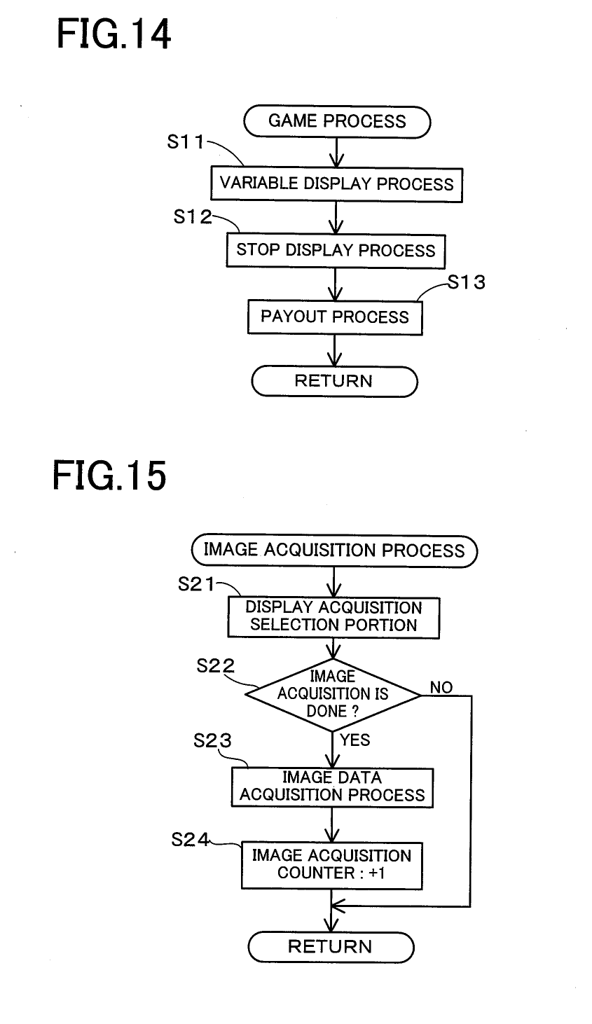

Next, each of the control programs which construct the main process program will be described in detail with reference to the drawings. At first, the game process program executed in the game process (S4) of the main process program will be described with reference to FIG. 14. FIG. 14 is a flowchart of the game process program. In the main process program, when the procedure is shifted to the game process (S4), the CPU 50 variable displays the video reel 100 in the variable display portions 22A to 22C, 23A to 23C, and 24A to 24C (S11). By this means, in the variable display portions 22A, 22C, 23A to 23C, and 24A to 24C, each of the video reels 100 is variably displayed while being scrolled from the top to the bottom. And, if the predetermined time elapsed since variably display starts, the CPU 50 will stop and display each of the symbol in the variable display respectively (S12). After the stop display process (S12) is executed, the CPU 50 will shift the procedure to S13.

In S13, the CPU 50 executes the payout process, in which the winning combination and award contents corresponding thereof are determined based on the stopped and displayed symbols in the variable display portions 22A to 22C, 23A to 23C, and 24A to 24C in the symbol lottery process (S6) and determined award is provided to the player. Concretely, the CPU 50 determines the winning combination (including the any odds winning combination and the line odds winning combination) and the payout based on the stopped and displayed symbols in each of the variable display portions and the payout table (see FIGS. 9 and 10). And, the CPU 50 provides the award including determined payout to the player. For example, if the random result of the symbol lottery process (S2) is the display pattern as shown in FIG. 13, the winning combination “BLUE7-RED7-ANY”, the winning combination “PLAM”, and the winning combination “CENTERD WILD” are realized as the line odds winning combination (see FIG. 9). And, the winning combination of “ANY-4 of PLUM” and “ANY-3 of ANY7” are realized as the any odds winning combination (see FIG. 10). Thereby, in the case of the random result shown in FIG. 13, the sum of the payouts “14” corresponding to line odds and any odds which are realized can be provided to the player in payout process (S13). In this case, as “WILD” 101 is stopped and displayed in the variable display portion, the award such as “the free game is won” is also provided. After payout process (S13) is finished, the CPU 50 finishes the game process (S4) and returns the procedure to the main process program.

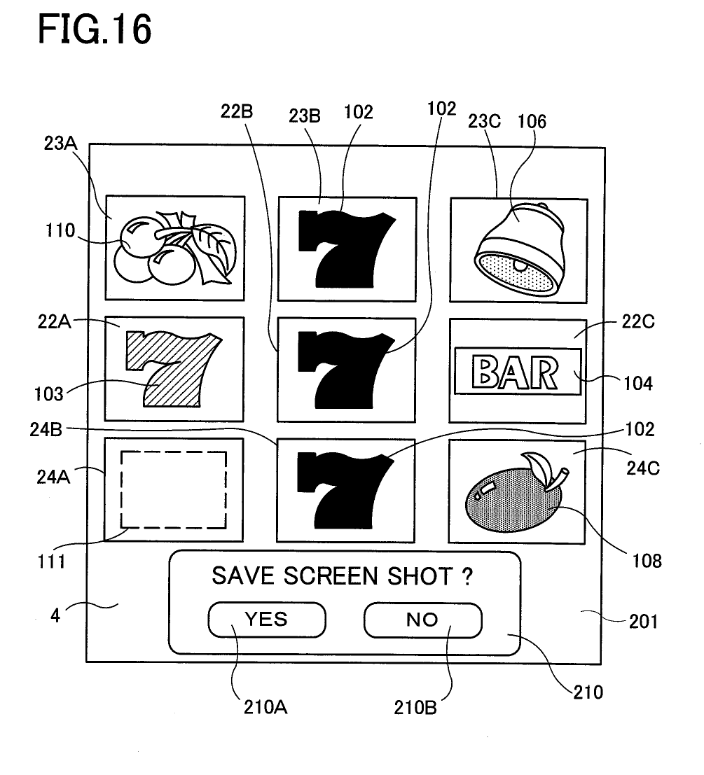

Next, the image acquisition process program executed in the image acquisition process (S6) of the main process program will be described in detail with reference to the drawings. FIG. 15 is a flowchart of the image acquisition process program. If the image acquisition lottery process (S3) is won and the procedure is shifted to the image acquisition process (S6), the CPU 50 will display the image acquisition selection portion 210 on the lower display 4 as shown in FIG. 16 (S21). The image acquisition selection portion 210 is displayed (for instance, at the bottom of nine variable display portions) on the lower display 4 (see FIG. 16.). Thereby, the player can certainly recognize the symbol pattern currently stopped and displayed in each of the variable display portions. Two selection operating portion 210A and 210B is formed in the image acquisition selection portion 210. Here, the selection operating portions 210A and 210B may form part or all of a user interface element. It is appreciated that other structures may be used in place of user inter face including buttons and the like. The selection operation portion 210A is the portion to be operated when the display contents currently displayed on the lower display 4 is acquired as the image data. On the other hand, the selection operation portion 210B is the portion to be operated when the image acquisition process (S6) is finished without acquiring the display contents currently displayed on the lower display 4 as the image data. After the image acquisition selection portion 210 is displayed on the lower display 4 (see FIG. 16), the CPU shifts the procedure to S22.

In S22, the CPU 50 determines whether the display content displayed on lower display 4 is acquired as the image data. That is, the CPU 50 determines based on the information which selection operating portion (the selection operating portion 210A or 210B) is operated. Concretely, the CPU 50 determines which selection operation portion (the selection operating portion 210A or 210B) is operated by the player based on the touch panel 201 and the touch panel drive circuit 202. If the selection operating portion 210A is operated (S22: YES), the CPU will shift the procedure to S23. On the other hand, if the selection operating portion 210B is operated (S22: NO), the CPU 50 will directly finish the image acquisition process (S6) without acquiring the image data corresponding to the display contents of the lower display 4.

When the procedure is shifted to S23, the CPU 50 stores the image data corresponding to the display contents displayed on the lower display 4 in the image data storage area 52A. In this time, the CPU 50 stores the image data in the image data storage area 52A one after the other by referring the value of the image acquisition counter 52B. For example, if the value of the image acquisition counter 52B is “1”, the image data will be stored in the second storage area of the image data storage area 52A. Here, when the image data is stored in the image data storage area 52A, the award data corresponding to the image data (namely, the data indicating the award contents provided based on the display pattern of the lower display 4) will be also stored.

Here, the case where the display pattern is displayed on the lower display 4 and the value of the image acquisition counter 52B is “3” will be described as an example. In this case, if the selection operating portion 210A is operated, the image data corresponding to the display pattern displayed on the lower display 4 will be stored in the fourth storage area of the image data storage area 52A. In the display pattern shown in FIG. 16, the winning combination “BLUE7” and “BLUE7-RED7-ANY” are won as the line adds winning combination (see FIG. 9). And more, the winning combination “ANY-4 of ANY7” is won as the any odds winning combination (see FIG. 10), so the award data indication payout number “45”, which the sum of the payout numbers corresponding to the line odds and the any odds, is also stored in the fourth storage area in addition to the image data.

And, after the image data indicating the display contents of the lower display 4 is stored in the image data storage area 52A, the CPU 50 adds “1” to the value of the image acquisition counter 52B (S24). After the value of the image acquisition counter 52B is added to “1” (S24), the CPU 50 finishes the image acquisition process (S6) and returns the procedure to the main process program.

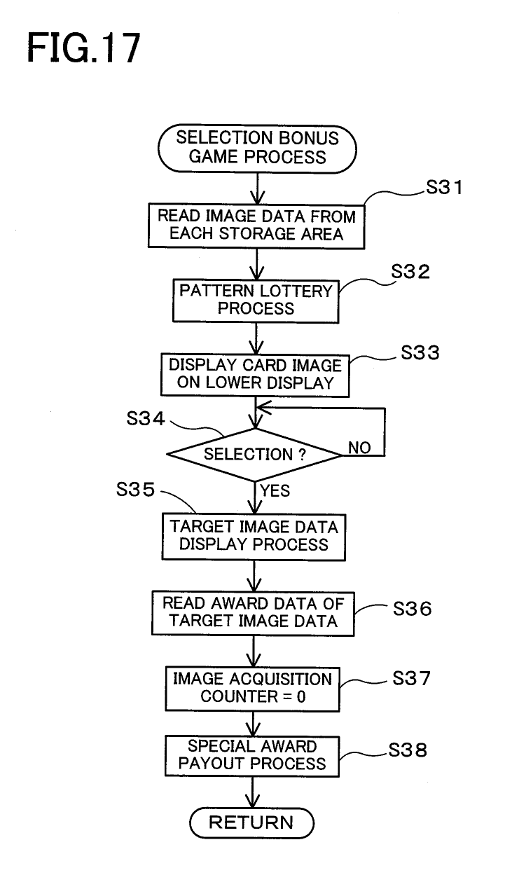

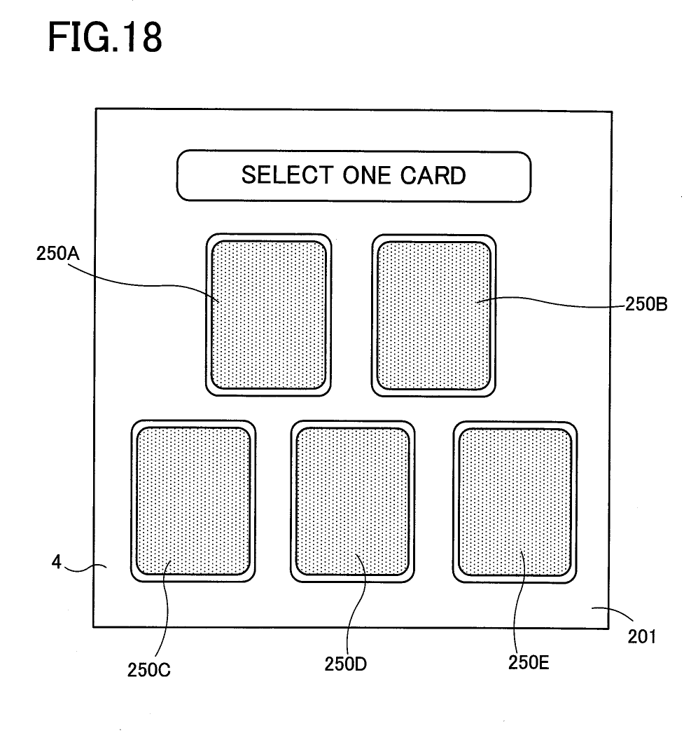

Next, the selection bonus game executed in the selection bonus game process (S10) of the main process program will be described in detail with reference to the drawings. FIG. 17 is a flowchart of the selection bonus game process. As mentioned above, in the selection bonus game of the slot machine in one or more embodiments, five card images 250 (the card images 250A to 250E) are displayed on the lower display 4 (see FIG. 18) and the game, which desired one card among five cards is selected, will be executed. Here, the shape of the card image is variable.

If the image data is stored in the first storage area to the fifth storage area of the image data storage area 52A respectively and the procedure is shifted to the selection bonus game process (S10), as shown in FIG. 17, at first, the image data will be read from the first storage area to the fifth storage area of the image data storage area 52A (S31).

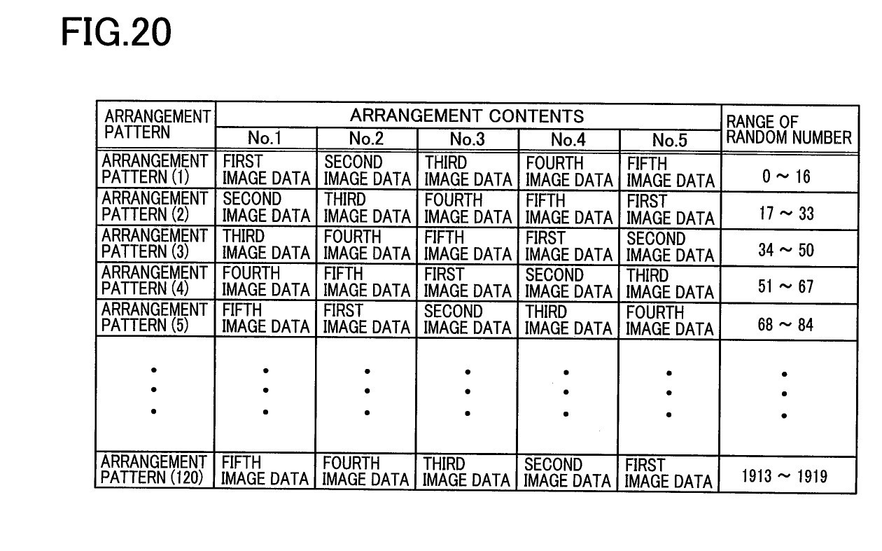

In S32, the CPU 50 determines the pattern, in which five card images 250 correspond to five image data stored in the image data storage area 52 (namely, arrangement pattern of the image data), by executing the pattern lottery process. Concretely, the CPU 50 samples one random number value, which lies in a range of “0” to “1919” (for instance), with the use of the random number sampling circuit 56, and determines the arrangement pattern of the image based on the random number value and the pattern lottery table (see FIG. 20) stored in the ROM 51.

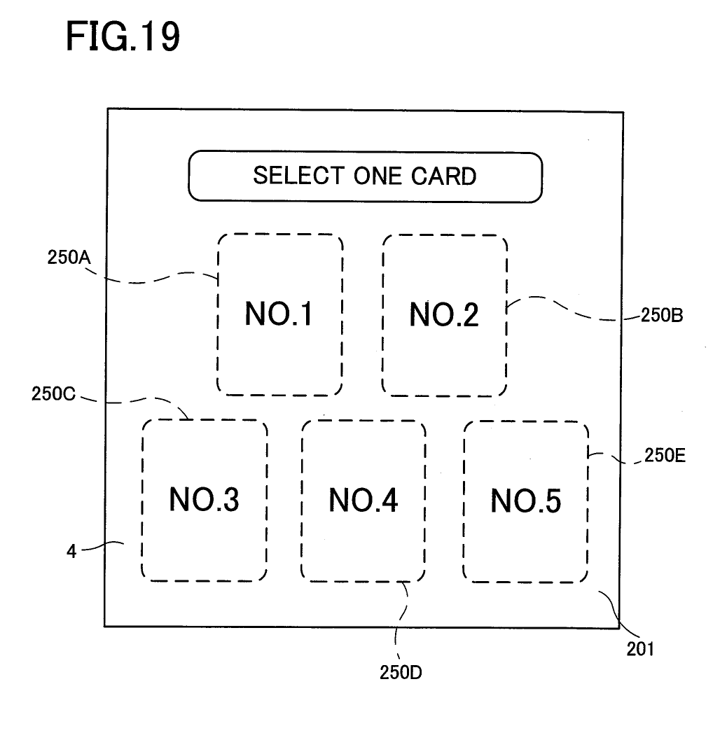

As shown in FIG. 18, in the selection bonus game, five card images are displayed on the lower display 4. That is, the card image 250A and the card image 250B are displayed at the upper portion of the lower display 4 (for instance, from the left to the right), and the card image 250C, the card image 250D, and the card image 250E are displayed at the lower portion of the lower display 4 (for instance, from the left to the right). And, as shown in FIG. 19, the card images 250A to 250E correspond to the location number indicating the location respectively. For example, the card image 250C corresponds to location number “3”, and the card image 250E corresponds to location number “5”.

Here, the pattern lottery table used in the pattern lottery process (S32) will be described in detail with reference to the drawings. FIG. 20 is an explanatory view schematically showing the pattern lottery table. As shown in FIG. 20, arrangement patterns of the image data (for example, one hundred and twenty patterns in one or more embodiments) are set in the pattern lottery table. The arrangement patterns correspond to the ranges of random number values respectively. Thereby, one random number value, which lies in a range of “0” to “1919”, is sampled and it is determined that the arrangement pattern of the image data is one arrangement pattern. For example, if the random number value lies in a range of “34” to “50”, it will be determined that the “arrange pattern (3)” is current arrangement pattern. In this case, the card image 250A corresponds to “the third image data” in which the image data stored in the third storage area, the card image 250B corresponds to “the fourth image data”. And, the card image 250C corresponds to “the fifth image data”, the card image 250D corresponds to “the first image data”, and the card image 250E corresponds to “the second image data”. Thereby, the CPU 50 samples one random number value with the use of the random number sampling circuit 56, and the CPU 50 determines the arrangement pattern based on the random number value and the pattern lottery table (see FIG. 20). After that, the CPU 50 stores the arrangement pattern data indication the determined arrangement pattern in the RAM 52 and the shifts the procedure to S33.

When the procedure is shifted to S33, the CPU 50 displays the five card images 250 and the message to promote selection for the player such as “SELECT ONE CARD” (for instance) on the lower display 4 (see FIG. 18). Here, the message is variable. After the card images 250A to 250E are displayed on the lower display 4, the CPU shifts the procedure to S34.

In S34, the CPU determines whether the card image 250 is selected by the player. That is, the CPU 50 detects the coordinate where the player touches with the use of the touch panel drive 202, and determines whether the card image 250 is selected based on the detection result. If the card image 250 is selected (S34: YES), the CPU 50 will identifies the selected card image 250 based on the coordinate detected by the panel drive circuit 202. And, the selection contents data indicating the identified card image 250 (for example, the location number as mentioned above) is stored in the RAM 52. After the selection contents data is stored in the RAM 52, the CPU shifts the procedure to S35. On the other hand, if the card image 250 is not selected (S34: NO), the CPU 50 will wait to the process until the card is selected.

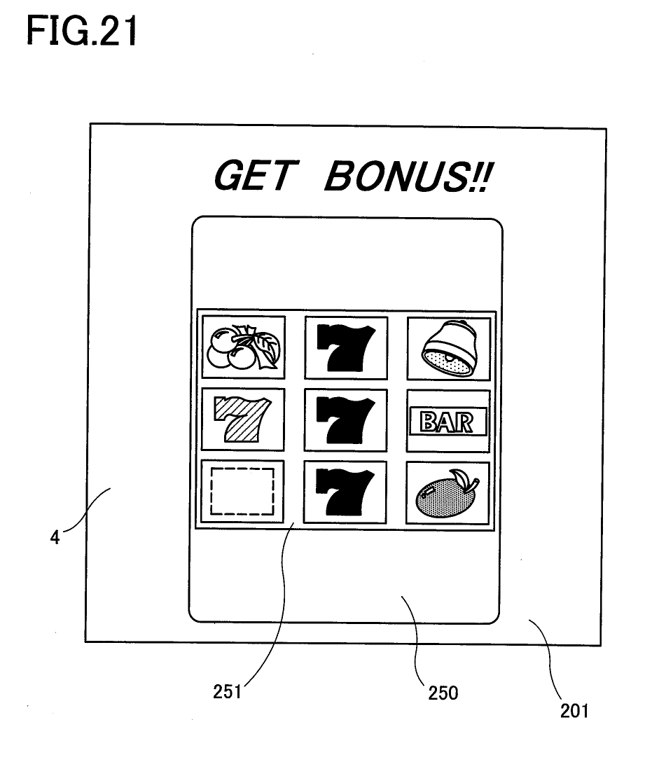

In 35, the target image data display process, which the image data corresponding to the selected card image 250 (hereinafter “target image data”) is displayed as the award contents display image 251 based on the selection contents data stored in the RAM 52 and the arrangement pattern, is executed. That is, the procedure is shifted to the target image data display process (S35), the CPU 50 reads the selection contents data (for example, the location number) and the arrangement pattern (for example, “the arrangement pattern 3”), and refers the pattern lottery table (see FIG. 20). Thereby, it is identified where the target image data is stored in storage area of the image data storage area 52A stored. After that, the CPU 50 reads the identified target image data from the image data storage area 52A and displays the award contents display image corresponding to selected card image 250 on the lower display 4 (see FIG. 21).

Here, above process will be described based on the example, in which display pattern shown in FIG. 16 is displayed on the lower display 4 and the image data indicating above display pattern is acquired. In this case, it is assume that “the arrangement pattern (2)” is stored in the RAM 52 as the arrangement pattern corresponding to the card image 250 and the image data. In this case, if the card image 250C is selected by the player, the selection contents data indicating “No. 3” will be stored in the RAM 52. And, the CPU 50 identifies that the target image data corresponding to the card image 250C is the image data stored in the fourth storage area of the image data storage area 52A (namely, the fourth image data) by referring the pattern lottery table (see FIG. 20) based on the selection contents data and the arrangement pattern data indicating “the arrange pattern (2)”. That is, in this case, the award contents display image 251 on the basis of the fourth image data (the image indicating the display contents shown in FIG. 16) is displayed on the lower display 4 as the award content of the card image 250C (see FIG. 21).

And, the procedure is shifted to S36, the CPU 50 reads the award data corresponding to the target image data identified in S35 from the storage area where the target image data is stored. That is, the award data, which indicates the award provided based on the combination of the stopped and displayed symbols in the variable display portions displayed on the lower display 4 when the image acquisition process (S6) corresponding to above image data, is read. For example, in the example shown in FIG. 21 as mentioned above, the CPU 50 reads the award data from the fourth storage area where the fourth image data is stored. In this case, on the combination of the fourth image data symbols, the line odds winning combination “BLUE7” 101 and “BLUE7-RED7-ANY”, and the any odds winning combination “ANY-4 of ANY7” are won (see FIG. 9, 10), so the award, in which corresponds to the payout number “45” which the sum of the payout numbers corresponding to the line odds and the any odds, will be read. After the award data corresponding to the target image data is stored in the RAM 52, the CPU shifts the procedure to S37.

If the procedure is shifted to S37, the CPU 50 resets the value of the image acquisition counter 52B to “0”. And, the CPU 50 executes the special award payout process, in which the award contents (namely, the payout number or the winning of the free game) is provided to the player as the special award (S38). Here, in the case of above example, the payout number “45” which is read as the award data is provided to the player as the special award. And, if the target image data is the data which indicates the display contents in which “WILD” 101 is stopped and displayed (for example, the display pattern shown in FIG. 13), “the winning of the free game” is provided as the special award in addition to the payout corresponding to the line odds winning combination and the any odds winning combination based on the combination of the symbol corresponding to the target image data. In the special award payout process (S38), after the special award provided to the player, the process, in which the display pattern of the lower display 4 is changed to the base condition (namely, the condition in which each of the variable display portions 22A to 22C, 23A to 23C, and 24A to 24C and activated pay lines L1 to L8 are displayed) and the image data stored in the first storage area to the fifth storage area of the image data storage area 52A is erased, is executed. After the special award payout process (S38) is finished, the CPU 50 finishes the selection bonus game process (S10), and returns the procedure to the main process program.

As mentioned above, in the slot machine 1 in one or more embodiments, the symbols are variably stopped and displayed in the variable display portions. And, if the combination of the stopped and displayed symbols is the line odds winning combination or the any odds winning combination, the award corresponding to realized winning combination (namely, the payout or the winning of the free game) will be provided. Here, if the image acquisition lottery process (S3) is won, after the symbols are variably displayed and stop displayed, the image acquisition selection portion 210 will be displayed on the lower display 4. In this time, the selection operating portion 201A of the image acquisition selection portion 210 is operated by the player (S22: YES), the image data indicating the display pattern displayed on the lower display 4 and the award data corresponding to the display pattern will be stored in the storage area 52A (S23). And, if the value of the image acquisition counter 52B is “5” (S9: YES), namely the amount of the image data stored in the image data storage area 52 reaches “5”, the selection bonus game process (S10) will be execute. In the selection bonus game process (S10), five card images 250 (the card images 250A to 250E) are displayed on the lower display 4, and the bonus game in which one card image 250 is desired selected by the player will be executed. Here, each of the card image 250 corresponds to the image data stored in the image storage area 52A acquired in the image acquisition process (S6). And, if one card image 250 is selected by the player, the award based on the combination of the symbols corresponding to the image data will be provided as the special award corresponding to the image data 250.

Here, as there exists various kinds of the combinations of the symbols corresponding to the image data, there exists various kinds of the special award contents based on the result of the selection bonus game (S10). That is, the game of the slot machine 1 can be various because of the variety of the special award in the selection bonus game process (S10), at the result, it can prevent that the player begin to feel that the game is monotonous. And, in the slot machine 1 in one or more embodiments, concerning the acquisition of the image data corresponding to the special award, the player can determine by his/herself whether the image is acquired based on the operation of the image acquisition section portion 210. That is, the player can determine the special award contents provided in the selection bonus game process by his/herself. At the result, concerning the game in the slot machine 1, as the player can consider that, for example, “whether the image in this game should be acquired”, “whether the image in next game should be acquired”, at the result, the player may develop an interest in the game such as developing strategy. And, in the slot machine 1, if the image data corresponding to high payout number is acquired in the image acquisition process (S6), the player will play the game to get the special payout corresponding to the image in the selection bonus game process (S10), so the player will be able to play the game in the slot machine 1 for a longer time. That is, in one or more embodiments of the present invention, the slot machine will be in use more frequently.

Here, aspects of the present invention are not limited to the above embodiment and various changes and modification can be done within the scope of the present invention. For example, in one or more embodiments, the acquisition image is performed when the image acquisition lottery process (S3) is won and the selection operating portion 210A of the image acquisition selection portion 201 is operated. However, the invention is not so limited. For example, the image acquisition selection portion 210 can always be displayed on the lower display 4, and the image can always be acquired when the game process is finished (S4).Also, the image data can be automatically acquired by the CPU 50 without determining whether the image is acquired by the image acquisition selection portion 210.

And, in the selection bonus game process (S10) in the slot machine 1 in one or more embodiments, five card image data is selectable where five image data correspond to five card image data and a five card image is displayed on the lower display 4. The invention is not so limited. For example, the image data corresponding to “YOU LOSE” (for instance) is always stored other than the image data acquired in the image acquisition process (S6), and the card image corresponds to that image data. Thereby, there exists the case that “YOU LOSE” can be selected, so the player experiences more excitement in playing the game as the game can be won or lost. And, in the selection bonus game process (S10), the image data respectively corresponding to the card images 250A to 250E is determined in the pattern lottery process (S32), although the invention is not so limited. For example, the image data, which is displayed on the lower display 4 based on the selection of the card image 250, is determined randomly.

And, in the free game process (S8) in one or more embodiments, if the winning combination “CENTERD WILD” is won, the symbols are variably stopped and displayed the variably stops and displays are performed in other variable display portions while “WILD” 101 is fix-displayed in the variable display portions 22B as the free game, however, one or more embodiments are not so limited. For example, if the winning combination “CENTERD WILD” is won, so-called double up game can be used as the bonus game.

Further, in the embodiment, although the selection bonus game is conducted when the value in the image acquisition counter 52B becomes “5”, the subject-matter is not limited to the above. For example, the selection bonus game may be conducted in a case that the specific symbol combination appears during the base game or the free game. And the selection bonus game may be automatically conducted after the free game. Further, the selection bonus game may be conducted in a case that another lottery other than the symbol lottery during the base game or the free game is done and the win is obtained in such lottery (like a mystery bonus).

And the image acquisition counter 52B may not be provided. In this case, the memory may be constructed so as to be able to store more than the number of the user interface elements and the number corresponding to the user interface element may be selected by the lottery from the image information stored in the memory and such selected number may be corresponded to the user interface element.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display configured to display image information;
a memory configured to store the image information;
user interface elements configured to be selected by a user; and
a processor programmed to:
associate the user interface elements with corresponding stored image information, and
provide an award based on the image information corresponding to a selected user interface element.

2. The gaming machine according to claim 1, wherein the processor is programmed to determine whether the award is to be provided based on the selected image information corresponding to the selected user interface element.

3. The gaming machine according to claim 1, wherein the processor is programmed to associate the user interface elements with corresponding stored image information in response to a predetermined amount of the image information being stored.

4. The gaming machine according to claim 1, wherein the processor is programmed to cause the memory to store the image information in response to user input.

5. The gaming machine according to claim 1, wherein the user interface elements include display objects displayed on the display, each of the display objects being associated with corresponding image information.

6. The gaming machine according to claim 5, wherein none of the display objects provide an indication as to their corresponding image information until one of the display objects is selected by a user.

7. A gaming machine comprising:
a display configured to display a plurality of symbols;
a memory configured to store image information including the symbols;
user interface elements configured to be selected by a user; and
a processor programmed to:
conduct a base game by using the symbols,
store the image information including a result of the base game in the memory if a first predetermined condition is satisfied, and
produce a bonus game in which selection by the user is conducted if a second predetermined condition is satisfied, the user interface elements and the image information stored in the memory being corresponded in the bonus game.

8. A method comprising:
displaying image information during a gaming session;
storing the image information;
associating user interface elements with corresponding stored image information;
receiving a selection of a user interface element; and
providing an award based on the image information corresponding to the selected user interface.

9. The method according to claim 8, further comprising:
determining whether the award is to be provided based on the image information corresponding to the selected user interface element.

10. The method according to claim 8, wherein the associating the user interface elements with corresponding stored image information is performed in response to a predetermined amount of the image information being stored.

11. The method according to claim 8, wherein the storing comprises storing the image information in response to user input.

12. The method according to claim 8, wherein the user interface elements include display objects, each of the display objects being associated with the image information.

13. The method according to claim 12, wherein none of the display objects provide an indication as to their corresponding image information until one of the display objects is selected by a user.

14. A tangible computer readable medium having computer-executable instructions stored thereon that, when executed by a processor, perform a method comprising the steps of:
displaying image information during a gaming session;
storing the image information;
associating user interface elements with corresponding stored image information;
receiving a selection of a user interface element; and
providing an award based on the image information corresponding to the selected user interface.

15. The tangible computer readable medium according to claim 14, further comprising:
determining whether the award is to be provided based on the image information corresponding to the selected user interface element.

16. The tangible computer readable medium according to claim 14, wherein the associating the user interface elements with corresponding stored image information is performed in response to a predetermined amount of the image information being stored.

17. The tangible computer readable medium according to claim 14, wherein the storing comprises storing the image information in response to user input.

18. The tangible computer readable medium according to claim 14, wherein the user interface elements include display objects, each of the display objects being associated with the image information.

19. The tangible computer readable medium according to claim 18, wherein none of the display objects provide an indication as to their corresponding image information until one of the display objects is selected by a user.
